(19) United States
(12) Patent Application Publication
(10) Pub. No.: US 2018/0218412 A1
(43) Pub. Date: Aug. 2, 2018

(54) METHOD AND APPARATUS FOR FUNDRAISING

(71) Applicant: Hyun Hwan An, Grinnell, IA (US)

(72) Inventor: Hyun Hwan An, Grinnell, IA (US)

(21) Appl. No.: 15/420,224

(22) Filed: Jan. 31, 2017

(51) Int. Cl. G06Q 30/02

(52) U.S. Cl. CPC G06Q 30/0279; G06Q 50/01; G06Q 30/0272; G06Q 30/0251

(57) ABSTRACT

The present invention comprises a method and means for fundraising, particularly crowd-funding. The inventive method provides a two-party donation regime. For a given cause or fundraiser seeking donations, a story. An advertiser or advertisers (the donor company/sponsor company) may then choose to sponsor one or more of the stories, presumably choosing those stories that align with the advertiser's interests. The donor company (advertiser) submits an advertisement for its product or service which will be shown each time the selected story is viewed. For each time its advertisement is shown, donor company pays (donates) a pre-determined fee to the fundraising party or cause. Viewers may elect to watch a story and its accompanying advertisement or elect to watch just the advertisement multiple times; the advertiser will pay the predetermined fee for each time the advertisement is watched, thereby funding the underlying cause.

### BACKGROUND

Fundraising by enticing donations from donors having interests aligned with the cause seeking donations has become an ever more important way for certain interests to be able to move forward. The key to fundraising, however, is two-fold; to attract a donor the first time and to entice that donor either to donate large amounts of money or to donate multiple times. The corporate donor is likely to have more funds at its disposal to donate than a person with ordinary income, however, its business interests are its top priority and compete for the use of those funds. Further, a corporation is more likely to donate where its donation will be noticed by the audiences most relevant to its business interests. This is why corporate donors are often acknowledged by, for example, listing the level of donation provided by it, or a plaque on a building identifying corporate sponsors of that building, etc. The more exposure of the donor and the favorability of that exposure to its intended audience, the more likely the corporate-type donor will be to participate in a given cause.

Individual donors contributing large sums of money often are motivated by acknowledgement of their contributions in the form of a permanent plaque or a listing somewhere. However, today's younger generation coined “millennials” (and others that are not of that generation by birth) have completely different decision-making patterns and motivations to purchase or donate than prior generations. Many are fairly young at this point in time having incomes that are comparatively small, and they seem to be a bit more aligned with philanthropic tendencies and motivations than generations of the past. In addition, like generations that have preceded them, their earning (and donating power) has yet to reach its peak which is still decades away. Millennials, as a group, are not as motivated as other generations to seek the highest income available by working long hours simply in return for money, where income is the main reward for effort. They are, instead, more motivated by lifestyle opportunities and a group mentality. Millennials are also far more socially conscious and aware than their predecessors. In addition, millennials and many others divide their entertainment and shopping experiences among the thousands of websites available including Facebook, Twitter, and other electronic information sharing/providing sites, rather than a relatively finite set of television stations and targeted radio stations. Those seeking donations from this generation by traditional fundraising means—and from people outside this generation who are like-minded—must invest heavily in the reach of their message and its content, understanding that although millennials and younger people in general may be reached by a well-constructed message, the resulting individual donation is likely to be small.

In addition to their differing information gathering and philanthropic motivations and how they act on them, millennials also have their very own communications style and tools. The vast majority obtain most of their information online rather than through television and radio like their predecessors. Many consume news via a favorite website, and belong to on-line communities that have participating members or viewers based on like interests. Further, rather than reading a print magazine or watching a television show sponsored through advertising, entertainment can be accessed directly, often with little or no participation by advertisers. Further, many people older than millennials are beginning to enjoy and take advantage of social media and other tools as a means to stay connected with people of similar interests as well as a means of entertainment sourcing.

### SUMMARY OF THE INVENTION

Those seeking charitable donations as a means to fund a cause are faced with a huge and very new challenge. The traditional means of raising funds through purchasing advertising space on television and radio, or even print advertising, are very unlikely to effectively reach young adults and a number of potential donors from other generations. And, reaching enough people effectively through on-line advertising by sponsoring a website or a product is equally challenging due to the vast number of websites competing for the attention of the online population. Further, while reaching this group by presenting an appealing message may, indeed, motivate donations by individuals, most likely, these donations will be small. The size of the donation is reduced because the donors will be bombarded by so many seeking donations; the donor will make smaller donations in order to contribute to more causes. And, of course, for the most part the newer generation has yet to meet its peak income and be able to make sizable, individual donations.

The youngest generations gather information and are entertained by completely different sources and have differing motivations and information gathering styles. They gather and share information electronically by using a variety of tools and platforms such as on-line shopping sources sponsored by a single entity or a platform providing access to goods from multiple sources. Because they are not physically present to try the product, or touch and feel the product, these buyers pay attention to ratings and opinions of the product provided by others. So, too, older generations are learning to take advantage of the on-line opportunities to communicate with others with like interests and common causes, and to gather information and others' opinions in order to make a purchasing decision. Today's world is full of people who are communicating with each other in innovative ways many of whom are joining on-line communities of like-minded individuals; checking boards and websites dedicated to relatively narrow interests to gain knowledge, and to connect with others.

Tools are often provided for “rating” or otherwise commenting on posted material. This group of consumers pays attention to its cohort's opinions, sometimes relying on those posted opinions as the most reliable source of information regarding a product's quality or the entertainment value of a new movie.

The present invention capitalizes on on-line communications tools and the evolving manner of communicating and socializing on-line. In particular, the present invention employs an on-line community wherein fundraisers can post stories crafted to present a cause and entice the reader/viewer to want to help or otherwise support that cause. Alternatively, these stories may have little or no connection to the cause supported by the fundraiser seeking funds. The user or viewer in the on-line community may view any story that they find to be of interest and, either when finished or at various points during the viewing or reading of the story, the participant is presented with an opportunity to help or support a cause by voluntarily viewing an advertisement sponsored by a donor/sponsor entity. Most often, the ad will be for a service or product offered by or somehow connected with the donor/sponsor entity. In exchange for the participant's viewing of the advertisement, the sponsor/donor entity will donate a certain amount to the associated cause of the fundraiser, thereby collected by the fundraiser as a donation. The inventive arrangement essentially creates a three-party donation scheme rather than the traditional two-party arrangement.

In a second embodiment, after the viewer views the story (or at some time during the viewing of the story), the viewer is presented with an opportunity to view the advertisement. Further, the viewer may be provided with a tool or tools with which to indicate his opinion of the advertisement and/or the story. Of course, there are other means online including unrelated online communities that the viewer may also use to share his enthusiasm for the story and/or the advertisement. In any case, the viewer is able to communicate his opinion of the story and/or of the advertisement via voting buttons, rating scales, written critique, etc. which the viewer can assign and associate with the story or the ad or both. These ratings and opinions are made available to other potential viewers. Other potential viewers will see the viewers' opinion indicators, and are enticed to view the story and the attendant ad. In one embodiment, functionality is provided so that the viewer may post a question about the story for response by its author or its sponsor. Alternatively, the system may allow the viewer to simply elect to view the ad (without the story), if she so chooses. Where a plurality of opinion indicators for a particular story or ad exist, at least some may I be consolidated and associated with the ad or story so that potential other viewers can select what to view according to the opinion indicators. In this manner, the story or ads with the “highest” ratings can be sought and/or identified by other potential viewers. The viewer may also be provided means to share his opinion; the opinions can be associated together and used to entice still others to view the story and/or advertisement, thereby increasing the amount of funds raised. Finally, it is expected that a viewer may post an opinion on a completely unrelated site where members of an unrelated on-line community may read about the ad or the story and be enticed to seek them out in response to the viewer's recommendations or critique.

Each time the advertisement is viewed, the system increases the view count for that advertisement. The advertiser donates to the fundraiser a pre-determined amount of each view of the advertiser's advertisement. This amount may vary depending on the number of viewers to date, the source of each new viewer, the rating of the advertisement by the viewers, or any of several other measures indicating the success of the ad relative to the number of times it is viewed. In some embodiments the donor may set a cap on the total possible donation such that the number of times the ad may be viewed (and donation be owed by the sponsor) will be limited by the system. In embodiments a single viewer may be limited to viewing a given ad only a certain number of times. Finally, the system is able to accommodate initial, full payment by the sponsor of the amount it is willing to donate, keep track of the number of views of the ad so sponsored, and calculate a refund for the sponsor if the number of views of the sponsored ad and the per view donation amount, together, do not meet the amount sponsored and deposited by the sponsor.

### BRIEF DESCRIPTION OF THE DRAWINGS

FIG. 1 provides a schematic outlining the flow of stories, donations, and activities of participants in the on-line community;

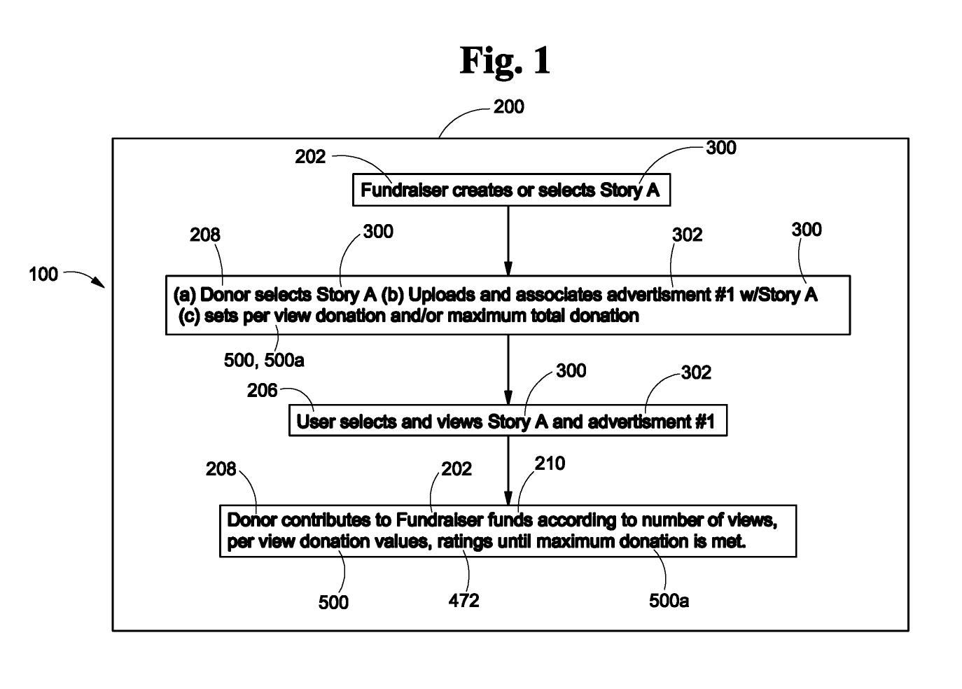

FIG. 2A illustrates the registration process for users;

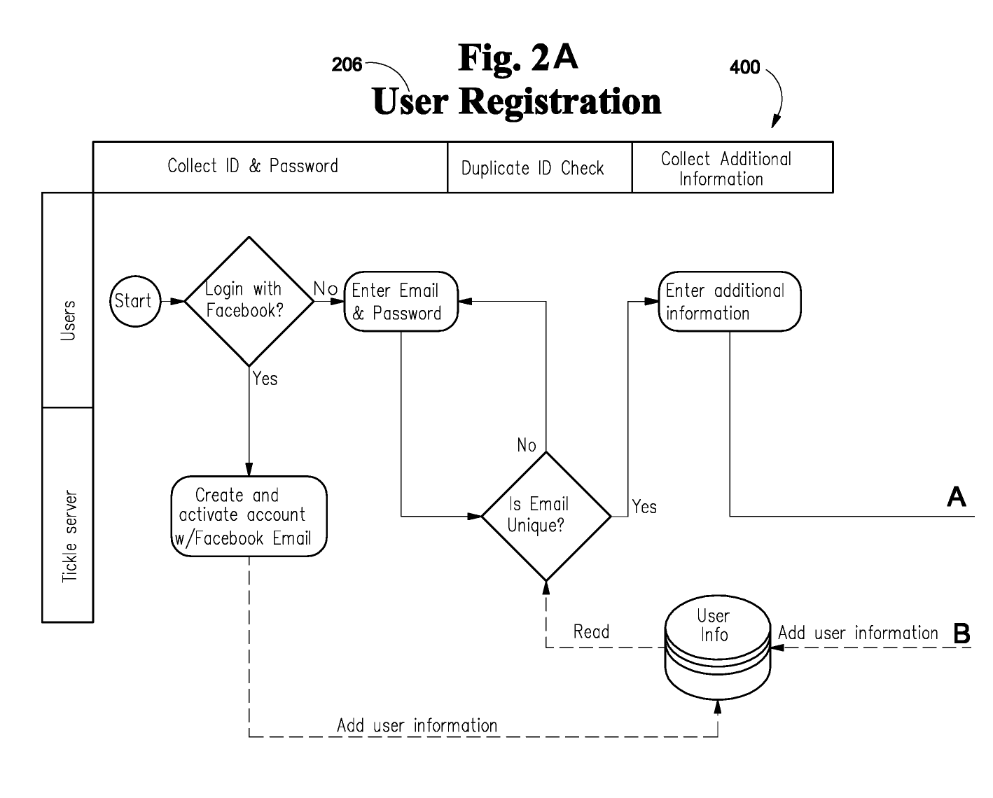

FIG. 2B illustrates the registration process for users and is a continuation of FIG. 2A;

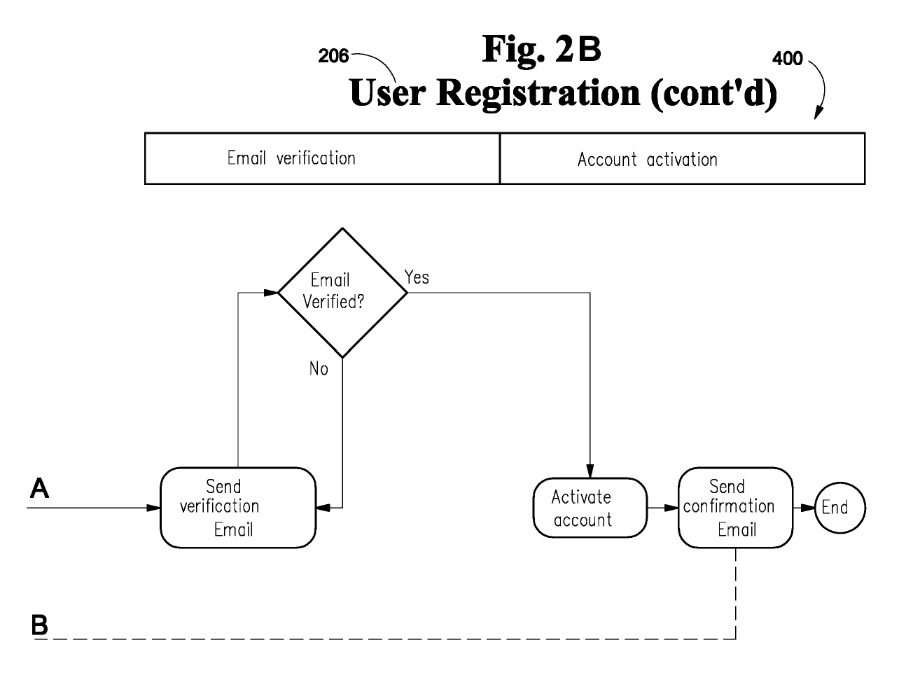

FIG. 3A illustrates the registration process for companies;

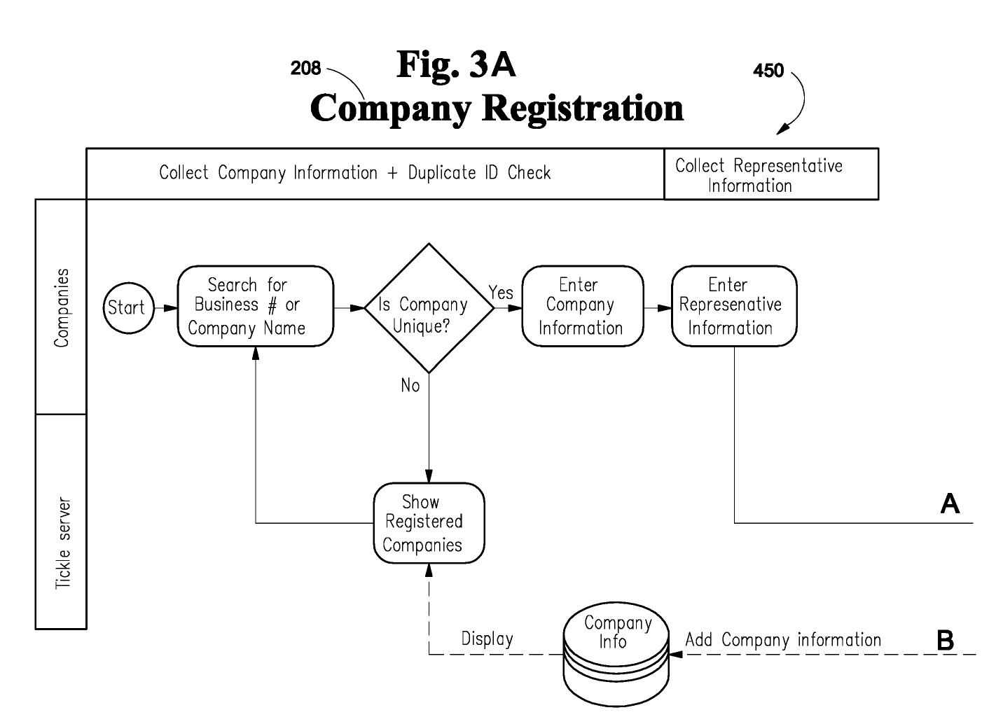

FIG. 3B illustrates the registration process for companies and is a continuation of FIG. 3a;

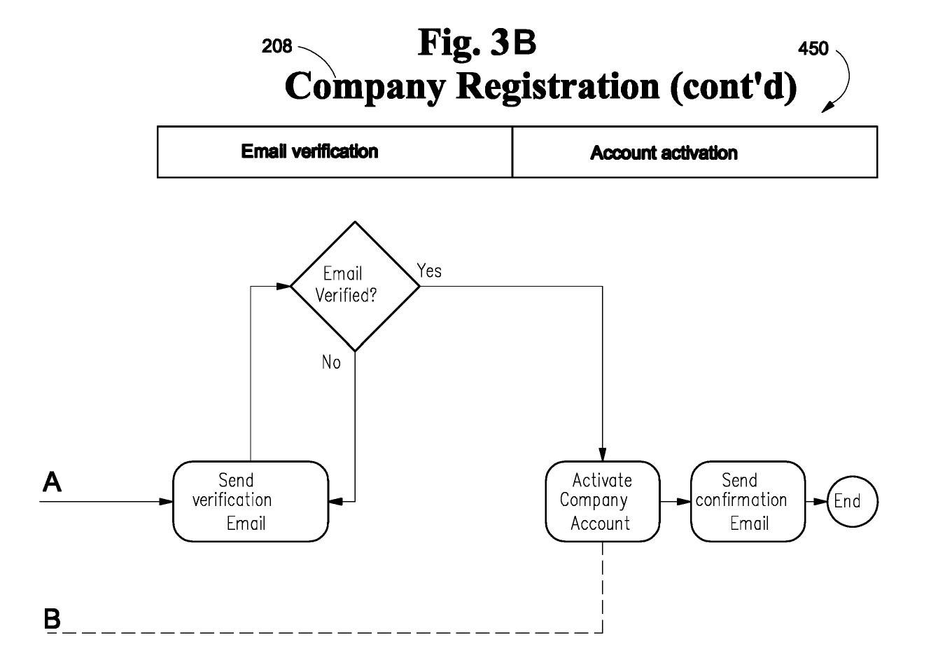

FIG. 4A provides a process overview of sponsor story selection, goal setting, deposit, and set up;

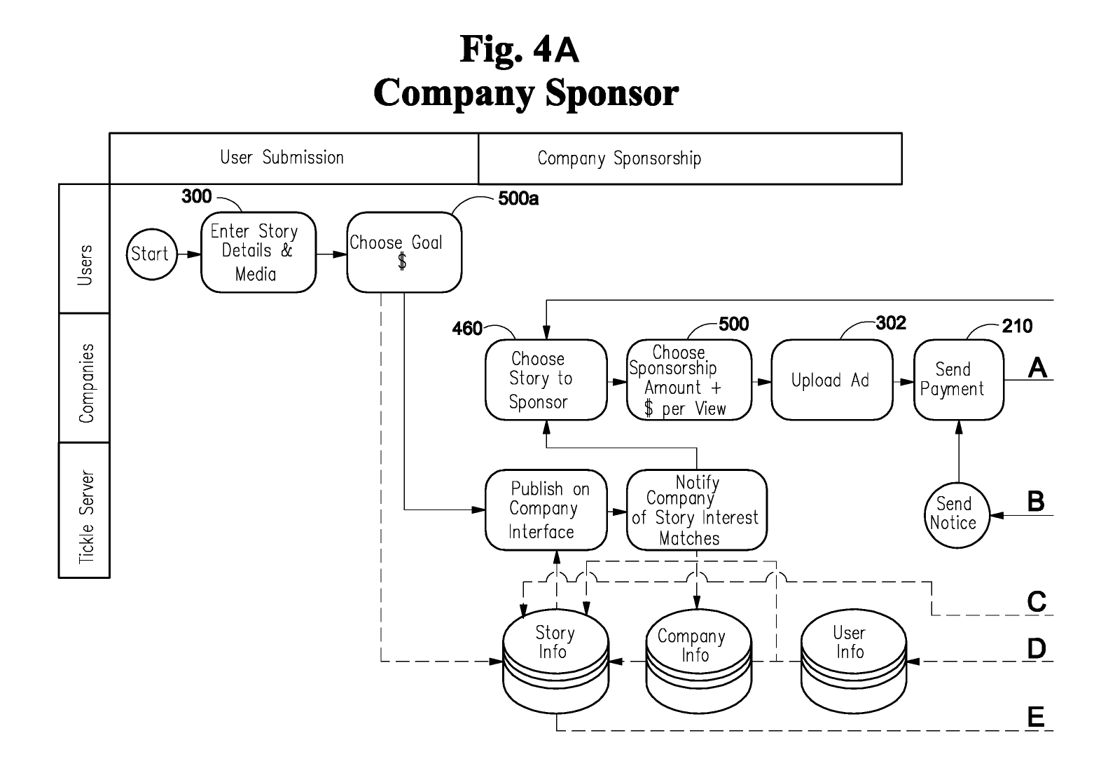

FIG. 4B provides a process overview of sponsor story selection, goal setting, deposit, and set up, and is a continuation of FIG. 4A;

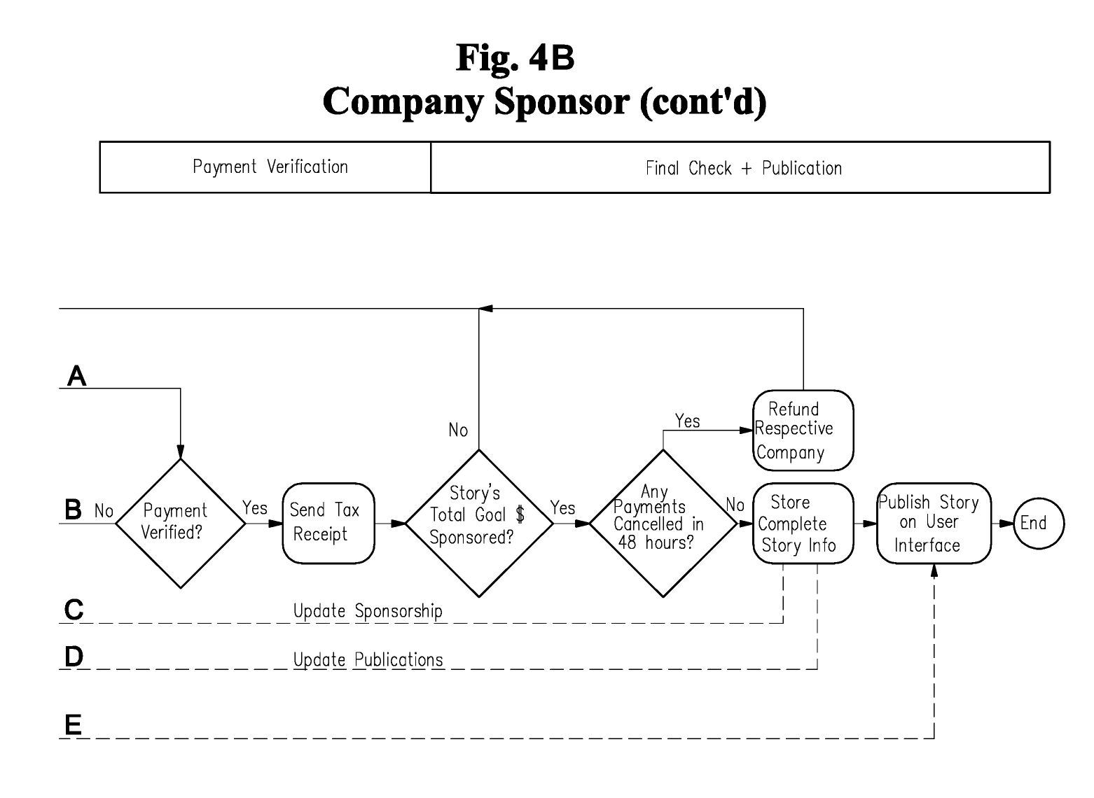

FIG. 5A shows user interaction options, and data storage related to each story viewed, ad selected, and donation;

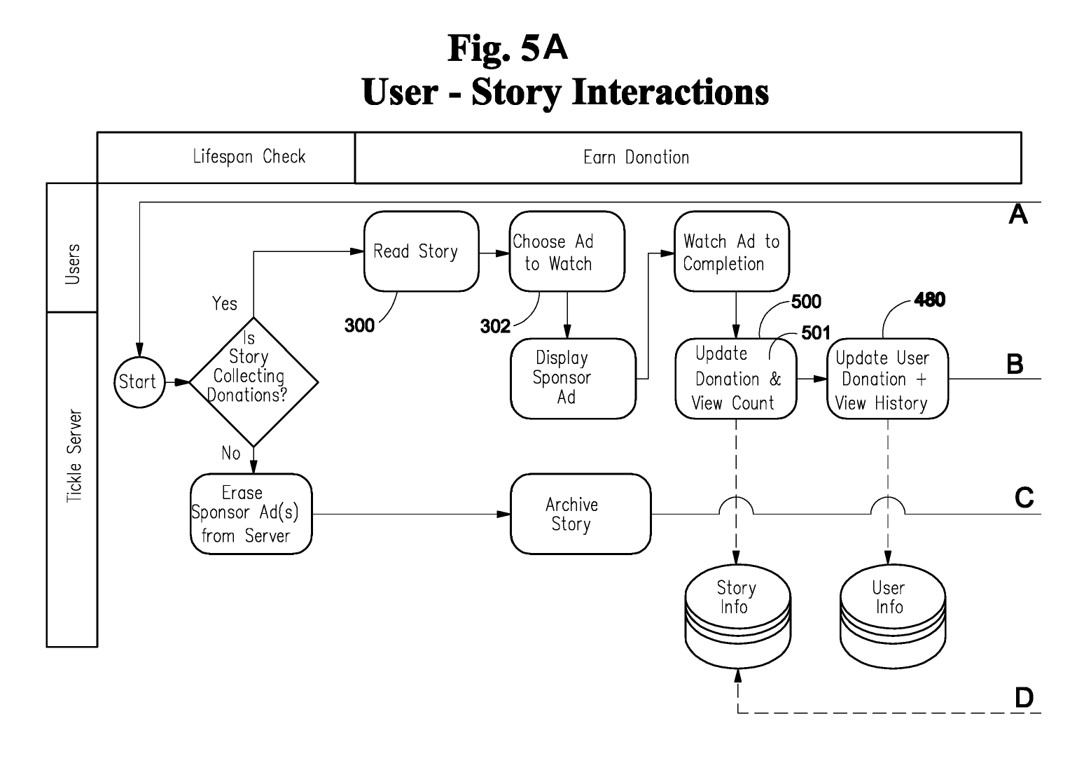

FIG. 5B shows user interaction options, and data storage related to each story viewed, ad selected, and donation and is a continuation of FIG. 5A;

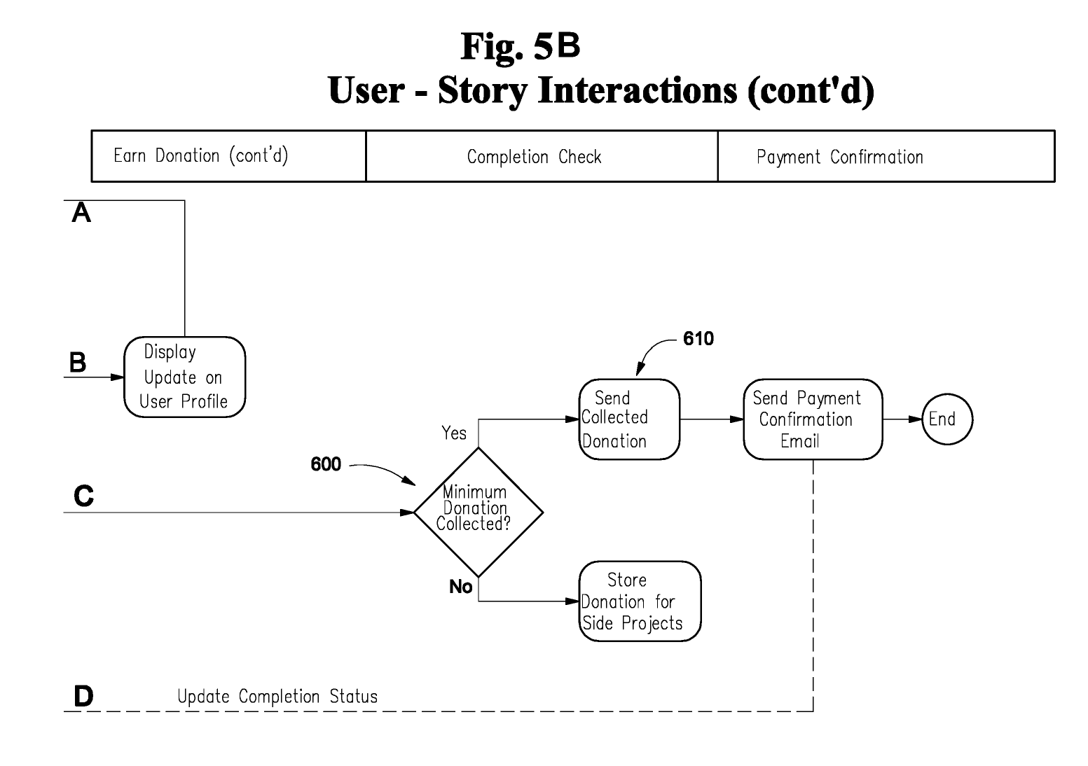

FIG. 6 is an example data points list for data regarding each of the three participant categories in the on-line community, fundraiser, viewer, donor/sponsor;

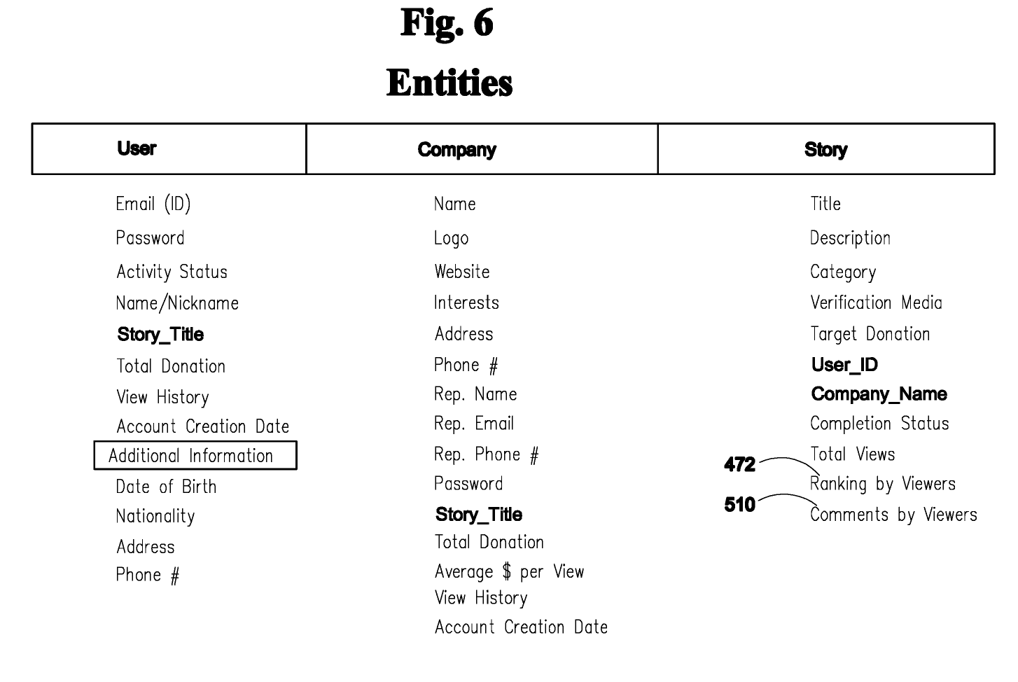

FIG. 7 illustrates rankings detail per sponsor;

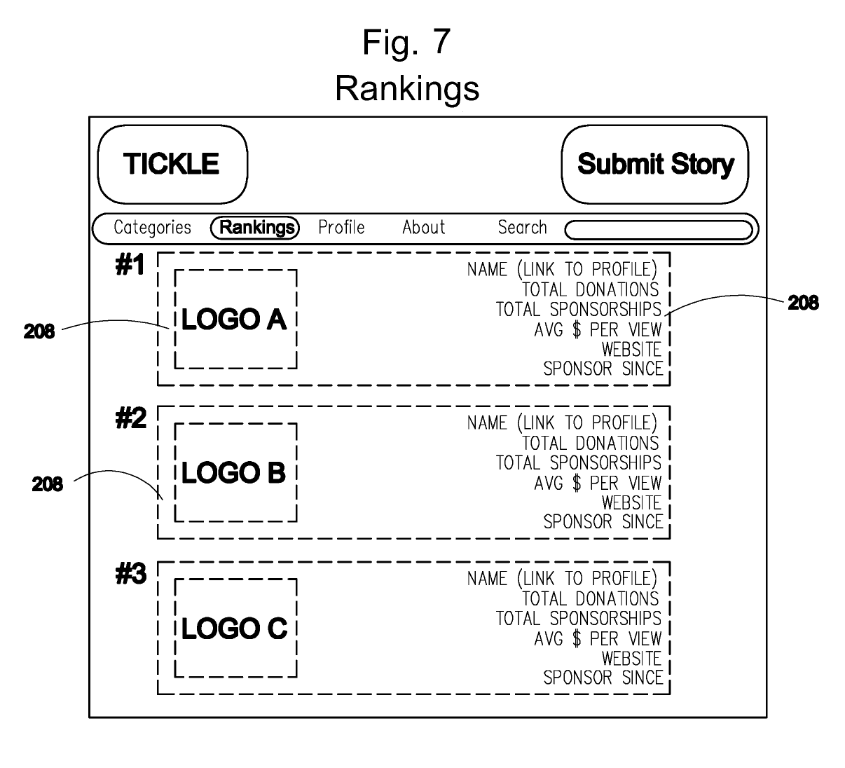

FIG. 8 shows an example screen providing details of activity related to a particular story, its sponsors, number of viewers, and donations;

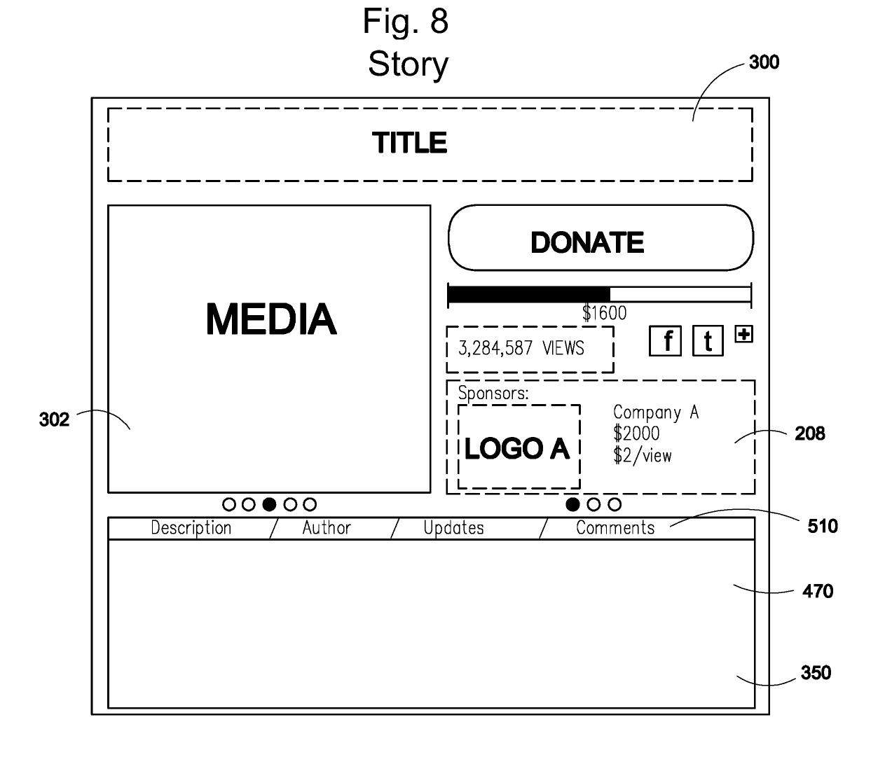

FIG. 9 shows an example screen depicting fundraising statuses of multiple stories;

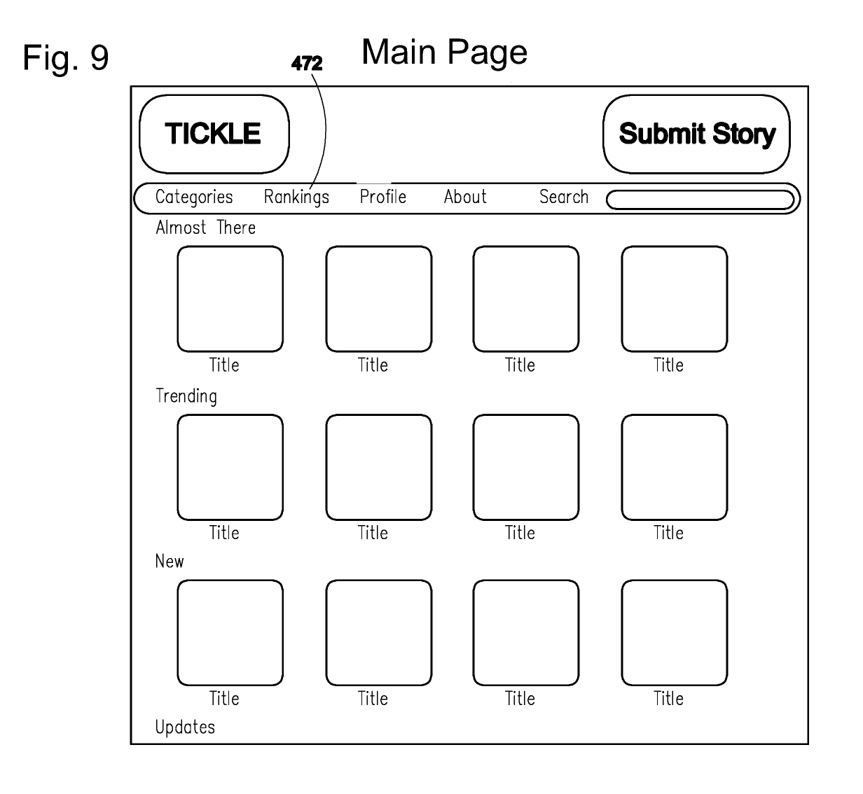

FIG. 10 shows an example screen presenting categories of stories from which the user may select;

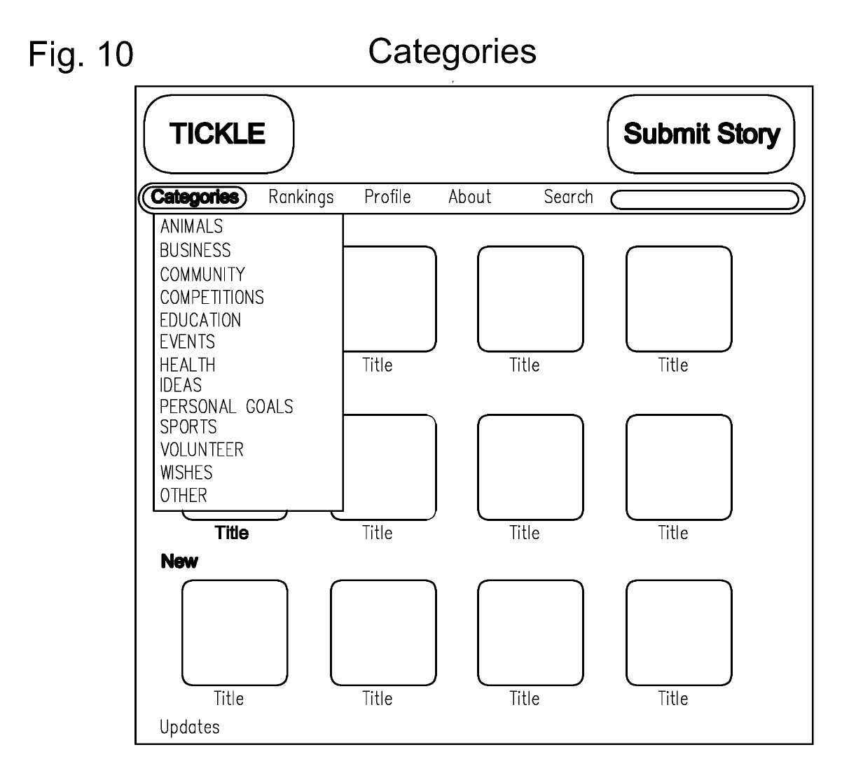

### DETAILED DESCRIPTION OF THE PREFERRED EMBODIMENT

The present invention comprises an on-line system 100 to facilitate and manage fundraising efforts for specified causes 204. The system 100 provides an online community 200 comprising at least one fundraiser 202 each said fundraiser having a cause 204, at least one user 206, and, at least one donor 208. The system further comprises at least one story 300, and at least one advertisement 302 said at least one advertisement 302 selected by at least one of said fundraisers 202. The system 100 provides a platform and functionality for raising funds 210 which are donated by a donor 208 in response to an action of one of the users 206.

The system 100 may include all or some of the following functions: user registration 400, sponsor company registration 450, fundraiser story selection 460. The fundraiser 202 registers, then prepares and/or selects at least one story 300 aligned with its cause 204. Next, a donor 208 selects a story 300 posted by a fundraiser 202 and uploads an advertisement 302 (or selects an advertisement 302 previously loaded) to be shown each time the donor's selected story 300 is viewed by a user 206. The donor 208 also elects a level of donation 500 for each view of the advertisement 302 by a user 206. The level of donation 500 may change based on the number of views of the ad 302. To that end, the system 100 may comprise a view counter 501. In one embodiment, the donor 208 may also select a limit or cap of total donations 500a and/or deposit only a set amount. The system 100 comprises functionality to track the number of views of the ad 302 and amount of donation 500 per view of that ad 302 from that donor 208. When the limit or cap of total donations 500a is reached and then the next user 206 selects the story 300 aligned with the cause 204, the system 100 may send a message that the associated ad 302 is no longer available or may allow the ad 302 to be shown, however, no donation 500 will be debited from the deposit 500a made by the donor 208. When the level of total donations 500 has met a predetermined limit or deposit 500a set by the donor 208, no additional donations will be recorded by the system. Each time the ad 302 is viewed, the system 100 computes the total donated by that donor 208 (or the limit 500a set for donation by the donor) for the ad 302 and compares it to the donation limit 500a set by the donor 208. When the total donated equals the donation limit 500a, the system 100 no longer debits donations from the deposit 500a. In some embodiments, once the donation limit 500a is met, the system 100 stops allowing views of the ad.

In another embodiment, a user 206 selects one of the stories 300 and views at least a portion of the story 300 and at least one of the advertisements 302 associated by a donor 208 with that story 300. When the advertisement 302 has been viewed by the user 206, the system 100 notifies the donor 208 and the donor 208 donates funds 210 in accordance with the level of donation 500 pre-selected by the donor. Alternatively, the donor 208 deposits the total amount 500a it is willing to donate, and each time the story 300 is selected and its ad 302 is viewed, the system debits the deposited amount 500a by the amount of the preset donation 500, until the deposited amount 500a reaches zero or until a predetermined time limit is reached. If the time limit is reached and some of the predeposited funds 500a remain, the system may be configured to compute and refund the remainder of the funds 500a to the donor 208. Alternatively, the system 100 records the number of donations and periodically notifies the donor 208 of the amount owed, and provides functionality allowing the donor 208 to deactivate its ad (and thereby cap its donation amount).

The system may include a view counter 501 to count the number of times a story 300 and/or an ad 302 has been viewed and/or means 470 for a user/viewer 206 to enter a rating 472 of the ad 302 or story 300 or provide a review 472 of the ad 302 or story 300, or any or all of the above. Means to rate/review the ad 470 (or story 300) may comprise a tabulator function 475 to gather and/or post the ratings 472 and reviews. These ratings 472 may be used internally by the fundraiser 202 to determine and monitor the success of its efforts to raise funds and adjust its story 300 and/or selection of donors 208. The ratings 472 for a given ad 302 (or story 300) may be posted where potential users/viewers 206 can see them and make story viewing selections accordingly. The ratings 472 for a given ad 302 or a given story 300 may be used by the system 100 to determine when the donation level 210 by the donor 208 should be adjusted, or to determine when predetermined thresholds of number of views or rating levels have been met, thereby causing the system to post a pre-selected category or comment 510 regarding the advertisement 302 to increase viewer 206 selection of the story 300 associated with that ad 302. Variations for each function may include changing the donation level 500 made by the donor 208 based on a total number of views of or based on the ratings 472 of the advertisement 302 posted by that donor 208. The system comprises tabulator 475 which may be flexible enough such that levels of donation may be triggered to increase based on a number of different metrics such as number of times an ad has been viewed, the ratings of the story provided by the users, the ratings of the ad provided by the users, the number of times the ad is viewed without its accompanying story, etc. Based on the ratings 472 of a story 300 and/or advertisement 302, a preselected category or comment 473 pertaining to that story 300 or advertisement 302 may be assigned to the relevant story 300 or advertisement 302. The system 100 may comprise a search engine or other means to allow a viewer 206 to search for stories based on the ratings 472 or comments 473 associated with the story, or based on the ratings 472 or comments 473 associated with the ad 302. The online community 200 may also or alternatively include means 350 for viewers 206 to post comments about a story 300 or ad 302 viewed, and may include a link from the comment to the story 300 or ad 302 viewed, thereby allowing the online community 200 to “push” views.

The system may also control a Facebook or other online community page where ratings of ads 302 and stories 300 are posted and from which a potential user/viewer may select a link to the system 100 to view the ad 302 and/or story 300, thereby taking advantage of social media tools already well-known to drive viewership (and fundraising).

Based on the ratings 472 of the story 300 or ad 302, or on the number of views of either or both, the system 100 may apply an algorithm 600 to calculate the amount of funds the donor owes to the fundraiser in a given time frame. The algorithm may be a direct relationship of per view fees for each view of the donor's advertisement, or may include varying per view amounts based on reaching different platforms of viewership. The algorithm may incorporate the viewer ratings 472 or comments 473 of the advertisement or of the story, In one embodiment, the donor is billed and pays through a bill pay function of the system. The algorithm 600 may further comprise functionality 610 to cause donation 500 to be sent to fundraiser 202 from fund 500a according to the number of views counted by view counter 501. The advertiser's advertisement 302 will not be available to viewers 206 if the donor 208 has not authorized payments of the owned funds.

In one embodiment, the system allows a viewer 206 to post a question for the donor 208 about the story 300, and for the donor 208 to respond.

We claim:

1. An online system 100 for fundraising comprising at least one fundraiser 202 seeking donations 210, at least one story 300, at least one donor 208, at least one advertisement 302 related to said at least one donor, and at least one user 206 wherein funds 210 are donated by at least one of said donors in accordance with actions of at least one of the said at least one users 206.

2. The system of claim 1, wherein at least one of said at least one fundraiser 202 submits a first story 300 to the system 100, and at least one said donor 208 submits at least one said advertisement 302 to the system 100.

3. The system of claim 2 wherein a plurality of fundraisers 202 each submits at least one said story 300 to the system 100 said story 300 related to a cause 204, and a plurality of donors 208 each submits at least one said advertisement 302 to the system 100.

4. The system of claim 2 wherein each said story 300 is associated with at least one said advertisement 302.

5. The system of claim 4 wherein each time a story 300 is viewed by a user 206 and said user 206 elects to view one of the at least one advertisements 302 posted by the donor 208 and associated with that story, the at least one donor 208 donates an amount of funds 210.

6. The system of claim 5 wherein each time a user views an advertisement the user is presented with means to rate the advertisement regarding at least one characteristic of the advertisement.

7. The system of claim 5 wherein the user may select and view the same story more than once and the at least one donor will donate said amount for each said view to a cause specified by the fundraiser.

8. The system of claim 5 comprising means to determine whether a story was fully viewed.

9. The system of claim 8 wherein means to determine comprises a response from the viewer to a prompt from the system at the end of the story.

10. The system of claim 5 wherein the user may select and view the same advertisement in response to any story it elects to view, and each time said same advertisement is elected, the donor will donate said amount of funds.

11. The system of claim 2 wherein said story comprises content related to a cause supported by the at least one donor.

12. The system of claim 5 further comprising means for said user to select a story for viewing, means for said user to select an ad for viewing, means for the user to evaluate the story or the ad, and means to make available to potential viewers composite evaluations of the story or the ad.

13. The system of claim 5 further comprising means for the user to link the story and system to a social media site.

14. The system of claim 13 comprising participants on the social media site wherein a participant may use the link to enter the system and view the story and the ad thereby causing the at least one donor 208 to donate an amount of funds 210. The system of claim 3 further comprising a sponsor registration function and means for said sponsor to view and select at least one story to sponsor.

15. The system of claim 6 further comprising means for the donor to limit the total amount that may be donated.

16. The system of claim 15, said system comprising functionality to record the number of times said ad is viewed, and debit an account of said donor for each view.

17. The system of claim 16, said system further comprising means to track and total donations made by said donor until such limit is met.

18. The system of claim 6 further comprising means for said user to post a message to one of said donor and said fundraiser and for one of said donor and fundraiser to respond.

19. A system for raising donated funds, said system comprising means for a fundraiser to post a story, means for a donor to post an advertisement and associate it with a story on the system and set an amount to be donated by the donor for each view of the advertisement, means for a user to select and view a story and advertisement and enter a rating.

20. The system of claim 19, said system further comprising means to collect the set amount to be donated from the donor for each view of the advertisement by a user.

21. A system for raising donated funds, said system comprising means to post a story and at least one associated ad, means for viewers of the story and the ad to post comments, and means for donors to donate funds according to the number of viewers of the ad.

22. The system of claim 21 further comprising means to determine whether the ad was completely shown.

23. The system of claim 21 wherein the donor may select a story with which to associate its ad.

24. The system of claim 21 further comprising a fundraiser to whom the donated funds will be donated.
